(19) United States
(12) Patent Application Publication
(10) Pub. No.: US 2017/0203485 A1
(43) Pub. Date: Jul. 20, 2017

(54) DELTA 3D PRINTER

(71) Applicants: XYZPRINTING, INC., NEW TAIPEI CITY (TW); KINPO ELECTRONICS, INC., NEW TAIPEI CITY (TW)

(72) Inventors: HUNG-HUAN SUNG, NEW TAIPEI CITY (TW); SHIH-HIS CHIANG, NEW TAIPEI CITY (TW); TZU-CHENG CHANG, NEW TAIPEI CITY (TW)

(21) Appl. No.: 15/053,689

(22) Filed: Feb. 25, 2016

(30) Foreign Application Priority Data
Jan. 20, 2016 (CN) 201610036651.5

(51) Int. Cl. B29C 47/06

(52) U.S. Cl. CPC B29C 47/06; B33Y 30/00

(57) ABSTRACT

A delta 3D printer includes a frame, standing rods, a print head module, and connection devices. Each connection device includes a sliding seat, a link set and joint mechanisms. The joint mechanisms are coupled at two ends of the link set respectively, and each joint mechanism includes a first joint, a second joint being capable of performing a two-dimensional swing motion, and a shaft being capable of performing a rotational motion; the shaft of each joint mechanism is pivoted with the print head module and the sliding seat respectively. Therefore, the print head can be moved smoothly during the movement.

### BACKGROUND OF THE INVENTION

Field of the Invention

The present invention generally relates to a 3D printer and, in particular to a delta 3D printer.

Description of Prior Art

With the progressing of the computer aided manufacturing (CAM), the developed 3D print can quickly produce prototypes of original design concepts. In further, 3D printed products do not have limitations in shapes, and its superior characteristics will be better performed from producing of complex parts. Because of saving lots of manpower and processing time, the popularity of the 3D printer is growing.

Now several types of 3D printers based on different design concepts are displayed on the market, wherein the most exceptional model with the most stable and fastest movement of the print head is the Delta 3D printer. Structures of the printer mainly includes a frame, pluralities of standing rods, a print head and a plurality of joint mechanisms, wherein two ends of each joint mechanism are connected with the standing rods and the print head respectively, and the connections of the joint mechanisms, the standing rods and the print head are achieved through universal joints.

Although traditional 3D printer can perform a printing function, it still has the following problems. The movement of the print head is presented in a stepwise shape (as shown in FIG. 1) due to a constriction of degrees of freedom of the universal joints during the moving process in all directions. As a result, the printed products will has a bad configuration that is needed to be improved.

### SUMMARY OF THE INVENTION

Accordingly, an object of the present invention is to provide a 3D delta printer, in which the shaft of the joint mechanism is capable of rotating in the sliding seat and the print head, thus a stable and parallel movement of the print head can be achieved.

In order to achieve the object mentioned above, the present invention provides a delta 3D printer comprising frame, a plural of standing rods and, a print head module and a plural of connection devices. The standing rods are erected at intervals in the frame. The print head module is disposed in an upper portion of the frame and located among the standing rods. The connection devices connects with the standing rods and the print head module respectively, and each of the connection devices includes a sliding seat, a link set and plural of joint mechanisms. The sliding seat slidingly contacts with the standing rods, and the joint mechanisms are coupled at two ends of the link set respectively. Each of the joint mechanisms comprises a first joint connected with the link set, a second joint connected with the first joint and being capable of performing a two-dimensional swing motion corresponding to the first joint and a shaft connected with the second joint and being capable of performing a rotational motion corresponding to the second joint, wherein the shaft of each joint mechanism is pivoted with the print head module and the sliding seat respectively.

Comparing to the prior art, the present invention provides connection devices which are spaced apart by 120 degrees so that the print head can be moved smoothly during the movement. Besides, the print head of the present invention has a stable and parallel movement for improving the print quality of products. Furthermore, the connection of the present invention is provided with plugs and positioned by binding rings, thus a fast assembly and installment can be achieved.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a trace graph of the movement of 3D print head of prior art;

FIG. 2 is a perspective schematic view showing the 3D delta printer of the present invention;

FIG. 3 is a schematic view showing the assembly of the print head and the connection device of the present invention;

FIG. 4 is a schematic view showing the assembly of the link set and the joint mechanism of the present invention;

FIG. 5 is a perspective exploded view showing the link set and the joint mechanism of the present invention;

FIG. 6 is a schematic view showing the assembly of the print head and one of the joint mechanisms of the present invention;

FIG. 7 is a trace graph of the movement of the movable platform of the present invention;

FIG. 8 is another embodiment of the print head and one of the joint mechanisms of the present invention.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

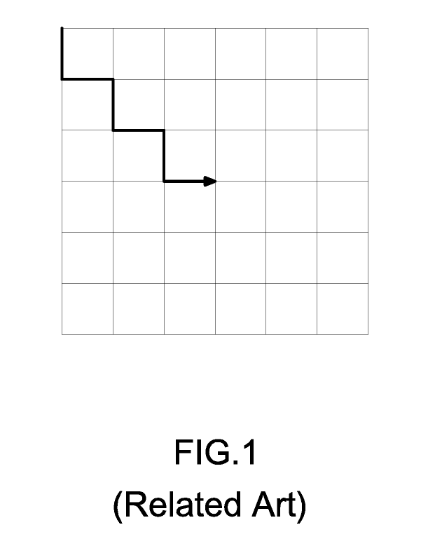

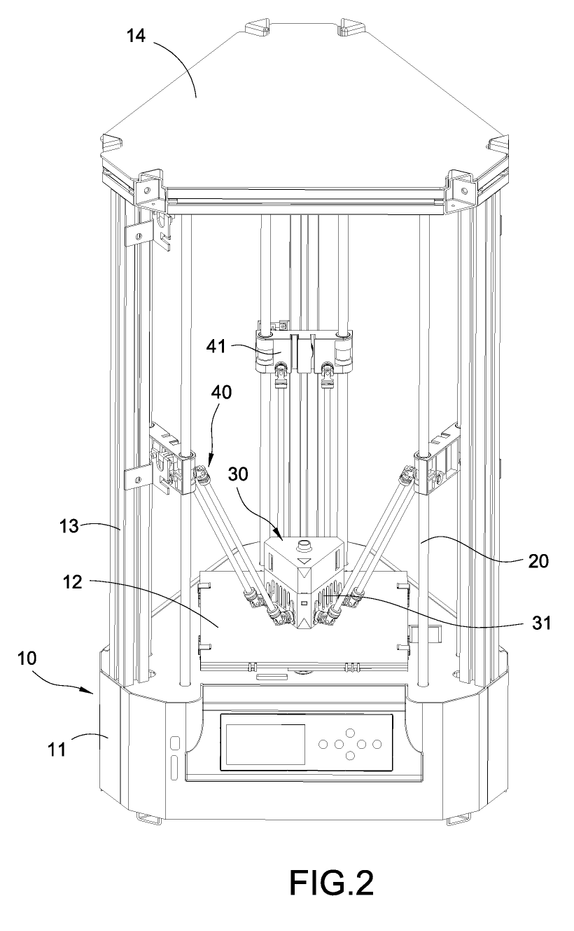

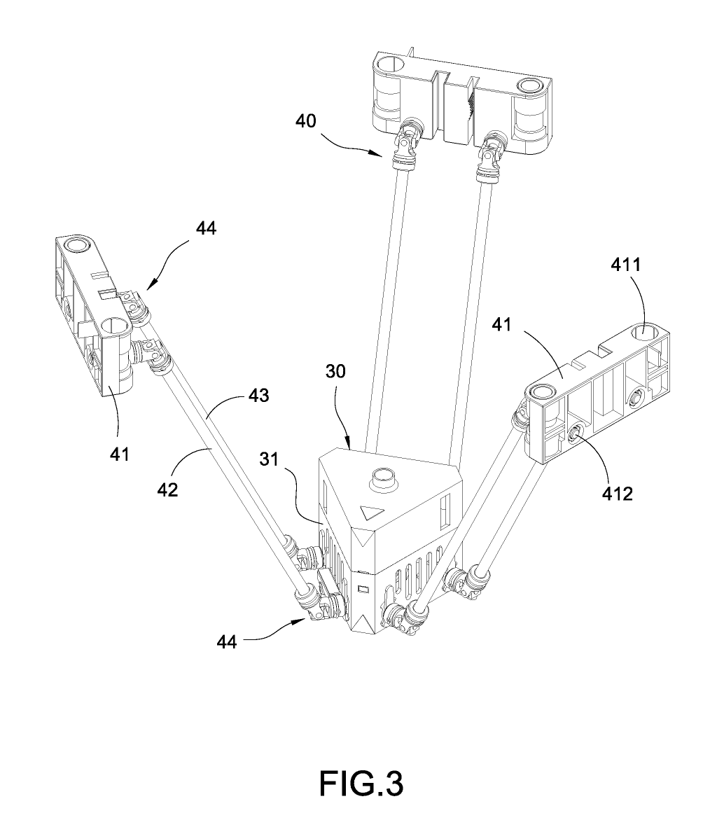

Please refer to FIG. 1 to FIG. 3, the delta 3D printer of the present invention includes a frame 10, a plural of standing rods 20, a print head module 30 and a plural of connection devices 40.

The frame 10 includes a seat body 11 being of substantially triangular configuration. A print platform 12 is disposed in the middle of the seat body 11, and a supporting rod 13 is installed at each corner of the seat body 11. Besides, a cover plate 14 is provided on a top of each supporting rod 13.

In the present embodiment, the quantity of the standing rods is six. The standing rods 20 are divided into three groups, and each group has two standing rods 20. Each group of the standing rods 20 is disposed at each corner of the seat body 11, and the standing rods 20 are parallel to each other and spaced apart.

The print head module 30 includes a movable platform 31 and a print head (not shown) mounted below the movable platform 31. The movable platform 31 is of substantially triangular configuration; it is disposed above the print platform 12 of the frame 10 and located among the standing rods 20.

Each connection device 40 is connected between the standing rods 20 and the print head module 30 individually, wherein the connection devices 40 are spaced apart by 120 degrees. In the present embodiment, the link set is designed and adopted by pairs. Therefore, each connection device 40 includes a sliding seat 41, a first link 42, a second link 43 and a plural of joint mechanisms 44, wherein the sliding seat 41, the first link 42, the second link 43 and one side of the movable platform 31 are configured in a parallelogram shape.

The sliding seat 41 is of substantially rectangular configuration; it is provided with a longitudinal hole 411 on both sides and a transverse hole 412 located in an inner side of each longitudinal hole 411 of the sliding seat 41. Moreover, the sliding seat 41 is sleeved with the standing rod 20 through the longitudinal hole 411 and slidingly contacts with the standing rod 20 through the transmission mechanism (not shown). The first link 42 and the second link 43 are parallel to each other and spaced apart. There is a through hole 421 at two ends of the first link 42 respectively; similarly, a through hole (not shown) is provided at two ends of the second link 43 respectively. The joint mechanism 44 is coupled at two ends of the first link 42 and the second link 43 respectively.

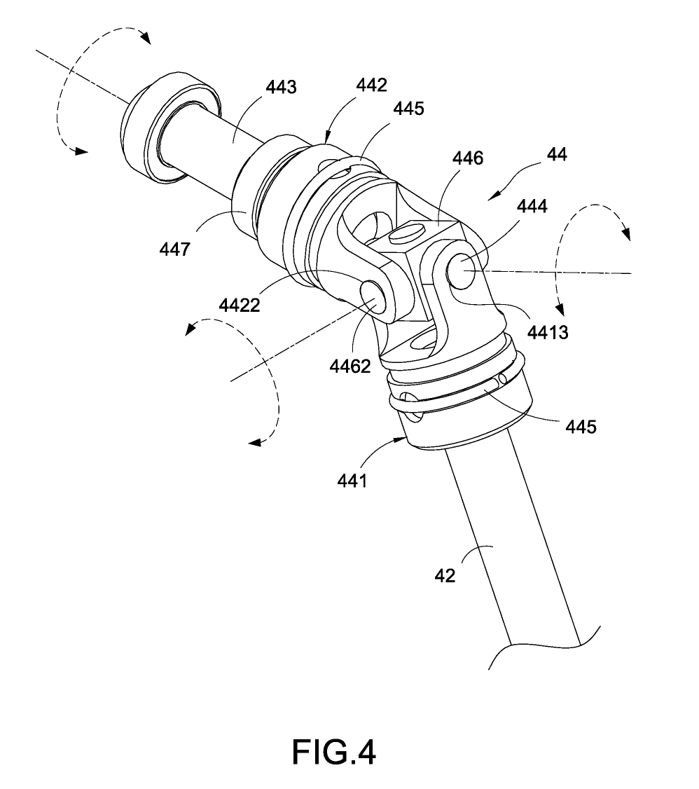

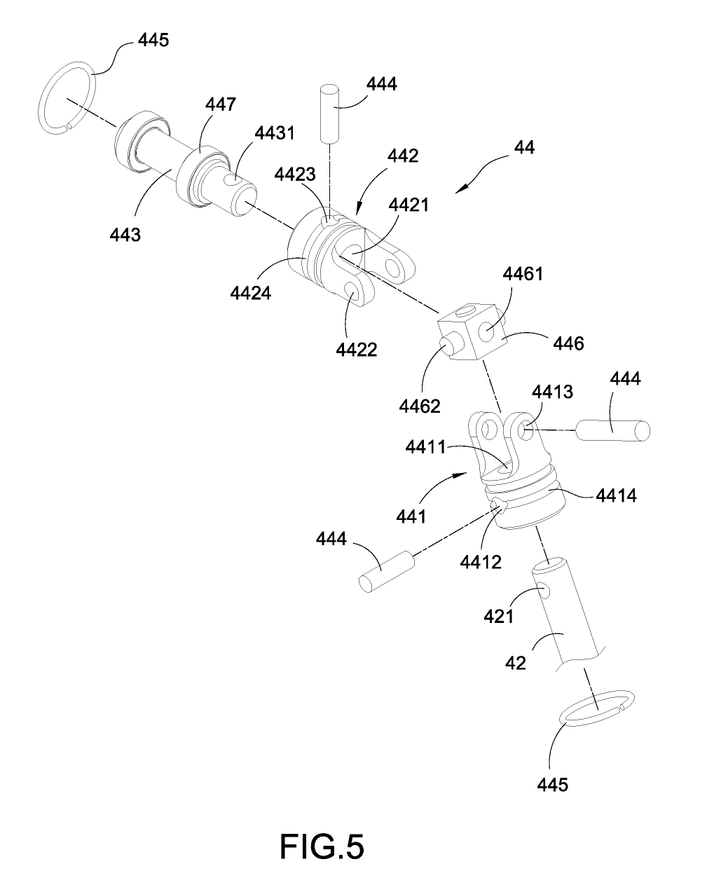

With referring to FIG. 4 and FIG. 5, each of the joint mechanisms 44 comprises a first joint 441, a second joint 442 and a shaft 443. The first joint 441 has a coupling hole 4411, a pin hole 4412 communicating with the coupling hole 4411 and a perforation hole 4413 provided on an upper portion of the first joint 441. In addition, the first joint 441 has an annular groove 4414 corresponding to the pin hole 4412, and the first link 42 is inserted in the coupling hole 4411 of the first joint 441. After the through hole 421 aligning with the pin hole 4412, a plug 444 is inserted in the pin hole 4412 and the through hole 421. Later, the plug 444 is blocked in the pin hole 4412 by a binding ring 445 looped in the annular groove 4414 correspondingly.

The structures of the second joint 442 are the same as the first joint 441. The second joint 442 has an axis hole 4421, a pillar hole 4422, a pin hole 4423 and an annular groove 4424. The second joint 442 is connected with the first joint 441 by a square block 446, and the square block 446 is provided with a pin hole 4461 and a set of columns 4462. The pin hole 4461 of the square block 446 is aligned with the perforation hole 4413 of the first joint 441, and then a plug 444 is riveted in the pin hole 4461 and the perforation hole 4413. Thus the columns 4462 are inserted in the pillar hole 4422 of the second joint 442, and the second joint 442 is capable of performing a two-dimensional swing motion corresponding to the first joint 441.

Moreover, one end of the shaft 443 is provided with an insertion hole 4431. The shaft 443 is inserted in the axis hole 4421 of the second joint 442. The insertion hole 4431 is aligned with the perforation hole 4423, and then a plug 444 is inserted in the insertion hole 4431 and the perforation hole 4423. Later, the plug 444 is blocked in the pin hole 4423 by a binding ring 445 looped in the annular groove 4424 correspondingly. For the joint mechanism 44 with respect to the sliding seat 41, another end of the shaft 443 is pivoted in the transverse hole 412 of the sliding seat 41 through a bearing 447; for the joint mechanism 44 with respect to the movable platform 31, the shaft 443 can also be pivoted in the hole (not shown) of the movable platform 31 through a bearing 447.

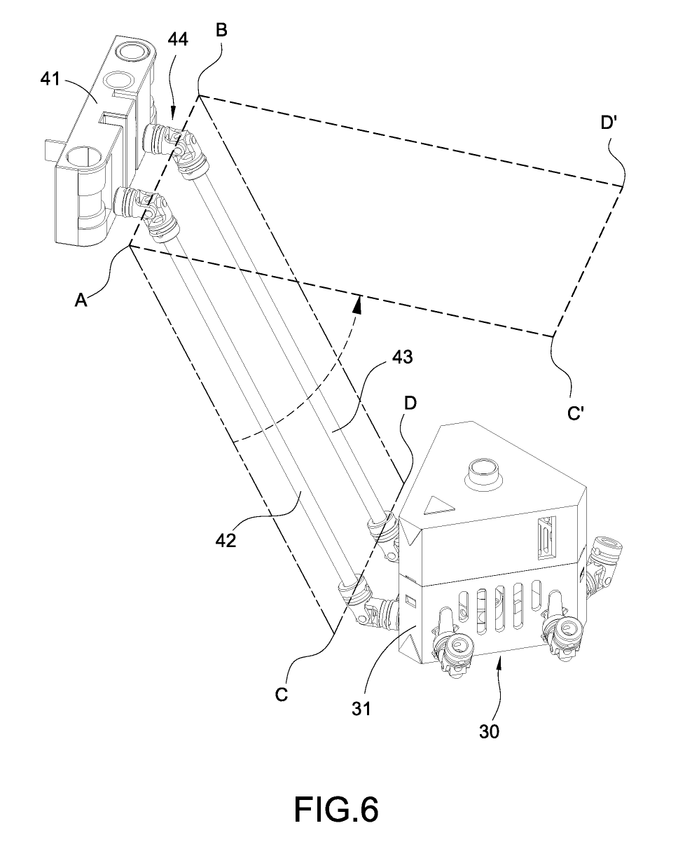

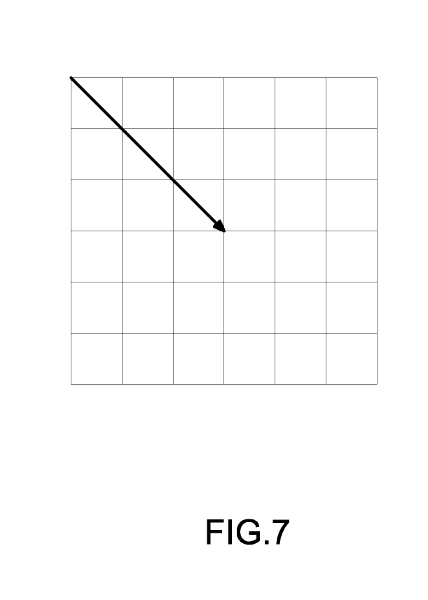

Please refer to FIG. 6 and FIG. 7, the sliding seat 41, the first link 42, the second link 43, and one side of the movable platform 31 are configured in a parallelogram shape. A parallelogram has the following characteristics: two opposite sides are parallel and equal; two opposite angles are equal, two adjacent angles are supplementary; two diagonals bisect each other; for any point on the plane always exists a line passing the point and dividing the parallelogram into two equal areas; the sum of the square of four side lengths equals to the square of two diagonals. The parallelogram shape configured by the joint mechanism 44 and the described components has node A, node B, node C and node D at each corner. Each sliding seat 41 moves along the standing rod 20 up and down when printing. The line of connection from the node A to the node B is a rotational axis at the node C and the node D. When the printer moves upward at the node C′ and node D′, the shaft 443 of each node A, B, C and D can be rotated according to the movement of the first joint 441 and/or the second joint 442. Therefore, the movement of the movable platform 31 will be presented in a line shape (as shown in FIG. 7) that can improve the print quality of products.

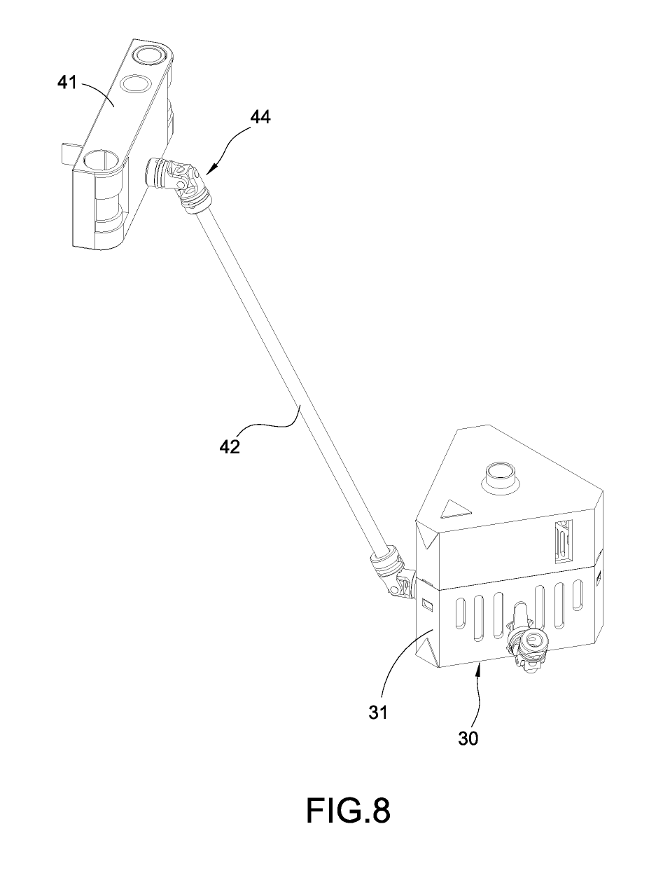

With referring to FIG. 8, the link set of the delta 3D printer of the present invention can be provided with only one link (first link 42). With the shaft 443 of each joint mechanism 44 (as shown in FIG. 4) is pivoted with the print head 30 and the sliding seat 41 respectively, each second joint 442 (as shown in FIG. 4) can be rotated with respect to the print head 30 or/and the sliding seat 41 through the shaft 43, thus a stable movement of the print head 30 can be achieved.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A delta 3D printer, comprising:
a frame;
a plural of standing rods erected at intervals on the frame;
a print head module disposed on an upper portion of the frame and located among the standing rods; and
a plural of connection devices connecting with the standing rods and the print head module respectively, each of the connection devices including a sliding seat, a link set and plural of joint mechanisms; the sliding seat slidingly contacting with the standing rods, the joint mechanisms coupled at two ends of the link set respectively; each of the joint mechanisms comprising a first joint connected with the link set, a second joint connected with the first joint and being capable of performing a two-dimensional swing motion corresponding to the first joint and a shaft connected with the second joint and being capable of performing a rotational motion corresponding to the second joint, wherein the shaft of each joint mechanism is pivoted with the print head module and the sliding seat respectively.

2. The 3D printer according to claim 1, wherein the print head module includes a movable platform, and the link set of each joint mechanism includes a first link and a second link being arranged in parallel and spaced apart with the first link; the sliding seat, the first link, the second link and one side of the movable platform are configured in a parallelogram shape of each connection device.

3. The 3D printer according to claim 1, wherein the quantity of the connection devices is 3, and the connection devices are spaced apart by 120 degrees.

4. The 3D printer according to claim 1, wherein one end of the link set is provided with a through hole, and the first joint has a coupling hole and a pin hole communicating with the coupling hole, the link set is inserted in the coupling hole and connected with the first joint by a plug inserting in the pin hole and the through hole.

5. The 3D printer according to claim 4, wherein the first joint has an annular groove corresponding to the pin hole, and the plug is blocked in the pin hole by a binding ring looped in the annular groove correspondingly.

6. The 3D printer according to claim 1, wherein one end of the shaft is provided with an insertion hole, and the second joint has an axis hole and a pin hole communicating with the axis hole, the shaft is inserted in the axis hole and connected with the second joint by a plug inserting in the pin hole and the insertion hole.

7. The 3D printer according to claim 6, wherein the second joint has an annular groove corresponding to the pin hole, and the plug is blocked in the pin hole by a binding ring looped in the annular groove correspondingly.

8. The 3D printer according to claim 1, wherein the sliding seat has a transverse hole, and the shaft is pivoted in the transverse hole through a bearing.

9. The 3D printer according to claim 1, wherein the joint mechanism further includes a block, and the block is provided with a pin hole and a set of columns; the first joint is provided with a perforation hole and connected with the block by a plug inserting in the pin hole and the perforation hole.

10. The 3D printer according to claim 9, wherein the block is extended with a set of columns, and the second joint is provided with a pillar hole; each of the columns is connected with the second joint by inserting in the pillar hole.
